(19) United States
(12) Patent Application Publication
(10) Pub. No.: US 2021/0320738 A1
(43) Pub. Date: Oct. 14, 2021

(54) SWICH, CONTROL APPARATUS, COMMUNICATION SYSTEM, COMMUNICATION CONTROL METHOD, AND PROGRAM

(71) Applicant: NEC Corporation, Minato-ku, Tokyo (JP)

(72) Inventor: Yasuhiro MIZUKOSHI, Tokyo (JP)

(73) Assignee: NEC Corporation, Minato-ku, Tokyo (JP)

(21) Appl. No.: 17/264,066

(22) PCT Filed: Jul. 31, 2019
(86) PCT No.: PCT/JP2019/029968

§ 371 Date: Jan. 28, 2021

(30) Foreign Application Priority Data
Aug. 1, 2018 (JP) 2018-145037

(51) Int. Cl. H04J 3/06; H04L 29/08; H04L 12/741

(52) U.S. Cl. CPC H04J 3/0667; H04L 45/745; H04L 67/12

(57) ABSTRACT

A switch includes a control entry holding part which holds a control entry(ies) set by a predetermined control apparatus; a packet processing part which processes a received packet with reference to the control entry(ies); a time synchronization part which performs time synchronization among a device(s) and an apparatus(es) mounted on a vehicle; and a state change part which changes a combination of the control entry(ies) which the packet processing part refers to using a time.

### REFERENCE TO RELATED APPLICATION

This application is a National Stage Entry of PCT/JP2019/029968 filed on Jul. 31, 2019, which claims priority from Japanese Patent Application 2018-145037 filed on Aug. 1, 2018, the contents of all of which are incorporated herein by reference, in their entirety. The present invention relates to a switch, a control apparatus, a communication system, a communication control method, and a program.

### FIELD

### Background

Patent Literature (PLT) 1 discloses a car video changeover module for displaying a necessary video on a monitor in response to a car driving condition without requiring a crew to operate a changeover switch. According to PLT 1, this video changeover module selects video signals from a plurality of receiving unit at the same time according to a priority order and outputs the video signal to the monitor.

PTL 2 discloses a configuration in which various types of modules onboard of the vehicle are connected through data communication buses (CAN) depending on intended uses. Here, CAN used in PLT 2 stands for Controller Area Network, and ECU stands for Electronic Control Unit.

PTL 3 discloses a video changeover device that can generate a composite synchronization signal for synchronization at a low cost without need of a synchronization signal generating means by generating a composite synchronization signal for synchronization using a video image from a camera or the like. According to PLT 3, a SYNC separation means 2 in this video changeover device separates a SYNC part in a video image of one of video input means 1A to 1N. Synchronization output means 3B to 3N output composite synchronization signals, based on the separated SYNC signal. A setting means 4 sets a switching timing of a video image in advance, and a control means 5 outputs a switching signal based on the switching timing set by the setting means 4 and the separated synchronization signal. Furthermore, a changeover means 6 switches video images from a plurality of video input means 1A-1N according to the switching signal and a video output means 7 outputs a switched video image.

In recent years, a technology called SDN (Software Defined Network) which realizes virtualization of a network using software is known. Non Patent Literature (NPL) 1 is OpenFlow Switch Specification which is used for building SDN.
PTL 1: WO2008/143079A1
PTL 2: JP2016-529151A
PTL 3: JPH11-317908A
NPT 1: OpenFlow Switch Specification Version 1.5.1 (Protocol version 0x06), ONF, [online], [searched on Jul. 18, 2018], Internet, <URL: haps://3vf60mmveq1g8vzn48q2o71a-wpengine.netdna-ss1.com/wp-content/uploads/2014/10/openflow-switch-v1.5.1.pdf>

### SUMMARY

The following analysis has been given from a viewpoint of the present invention. A configuration of PLT 1 needs a wire harness which simultaneously accommodates a lot of camera video images and a high performance ECU to process these video images. Therefore, there are problems that a cost and power consumption become high. In the future, as automated driving technologies make progress, the number of cameras and their resolutions will increase, and therefore it is desired to reduce a wire harness length and power consumption.

By applying the SDN of NPL 1 to the in-vehicle network exemplified in PLT 1, it becomes possible for a plurality of ECUs to share a line having a large transmission line capacitance whereby it is expected that a cost and power consumption can be reduced. However, in SDN in NPL 1, because a scheme is employed, in which control entries (flow entries) are set one by one as a general rule, timings when the control entries are enabled deviate, whereby it is assumed that there is a problem that change in state of the vehicle cannot be responded immediately. Furthermore, due to delay in setting the control entry(ies) to a part of switches in a communication path, packet loss will occur, and it is expected that unnecessary inquiries will be made to the SDN controller from the switches whose setting is delayed.

Furthermore, the above problems are common problems not only to the in-vehicle network but also to a centralized control type network represented by the SDN.

Accordingly, it is an object of the present invention to provide a switch, a control apparatus, a communication system, a communication control method, and a program which can contribute to reduce deviation of timings when the control entries are enabled in a switch(es) of a network to which an SDN is applied.

According to a first aspect, there is provided a switch, including: a control entry holding part which holds a control entry(ies) set by a predetermined control apparatus. The switch further includes a packet processing part which processes a received packet with reference to the control entry(ies). The switch further includes a time synchronization part which performs time synchronization among a device(s) and an apparatus(es) mounted on a vehicle. The switch further includes a state change part which changes a combination of the control entry(ies) which the packet processing part refers to using a time for which the time synchronization has been performed.

According to a second aspect, there is provided a control apparatus, including: a time synchronization part (control apparatus side time synchronization part) which performs time synchronization among a device(s) and an apparatus(es) mounted on a vehicle; a control entry setting part which sets a control entry(ies) to a switch(es) to be controlled; and a change control part which instructs change of a combination(s) of the control entry(ies) to the switch(es) to be controlled by designating a time for which the time synchronization has been performed.

According to a third aspect, there is provided a communication system including the switch(es) described above and the control apparatus described above.

According to a fourth aspect, there is provided a communication control method, wherein in a switch including: a control entry holding part which holds a control entry(ies) set by a predetermined control apparatus; and a packet processing part which processes a received packet with reference to the control entry(ies); the following are performed, including: performing time synchronization among a device(s) and an apparatus(es) mounted on a vehicle; and changing a combination of the control entry(ies) which the packet processing part refers to using a time for which the time synchronization has been performed. The present method is tied to a particular machine, namely, a switch including the control entry holding part and the packet processing part.

According to a fifth aspect, there is provided a computer program that realizes functions of the switches. It is to be noted that this program can be recorded on a computer-readable (non-transient) storage medium. That is, the present invention can be implemented as a computer program product.

According to the present invention, it becomes possible to reduce deviation of timings when the control entries are enabled in a switch(es) of a network to which an SDN is applied. That is, the present invention converts a switch of a centralized control type network represented by the SDN as described in background to one in which the deviation of timings when the control entries are enabled is reduced.

### BRIEF DESCRIPTION OF DRAWINGS

FIG. 1 illustrates a configuration of an example embodiment of the present invention.

FIG. 2 illustrates an operation of the example embodiment of the present invention.

FIG. 3 illustrates an operation of the example embodiment of the present invention.

FIG. 4 illustrates a configuration of a communication system (in-vehicle network system) of a first example embodiment of the present invention.

FIG. 5 illustrates a configuration of a switch of the first example embodiment of the present invention.

FIG. 6 shows a sequence diagram illustrating an operation of the first example embodiment of the present invention.

FIG. 7 illustrates an operation of the first example embodiment of the present invention.

FIG. 8 illustrates a changing method of control entries of the first example embodiment of the present invention.

FIG. 9 illustrates an operation of a second example embodiment of the present invention.

FIG. 10 illustrates a changing method of control entries of the second example embodiment of the present invention.

FIG. 11 illustrates an operation of a third example embodiment of the present invention.

FIG. 12 illustrates a changing method of control entries of the third example embodiment of the present invention.

FIG. 13 illustrates a changing method of the control entries of the third example embodiment of the present invention.

FIG. 14 illustrates a changing method of the control entries of a fourth example embodiment of the present invention.

FIG. 15 illustrating a configuration of a computer making up a switch or a control apparatus of the present invention.

### PREFERRED MODES

First, an outline of an example embodiment of the present invention will be described with reference to drawings. Note, in the following outline, reference signs of the drawings are denoted to each element as an example for the sake of convenience to facilitate understanding and description of this outline is not intended to any limitation. An individual connection line between blocks in drawings and so on referred to in the following description includes both one-way and two-way directions. A one-way arrow schematically illustrates a principal signal (data) flow and does not exclude bidirectionality. Furthermore, while not illustrated, an input port(s), an output port(s) or interfaces exist at connection points of input/output of each block in drawings. Programs are executed through a computer apparatus, and the computer apparatus includes, for example, a processor, a storage device, an input/output apparatus, a communication interface, and a display device as needed. Furthermore, the computer apparatus is configured to be able to communicate with an apparatus internally or with an external apparatus (including a computer) irrespective of whether it is wired or wireless through communication interfaces. Furthermore, in the following description, “A and/or B” is used to mean at least one of A or B.

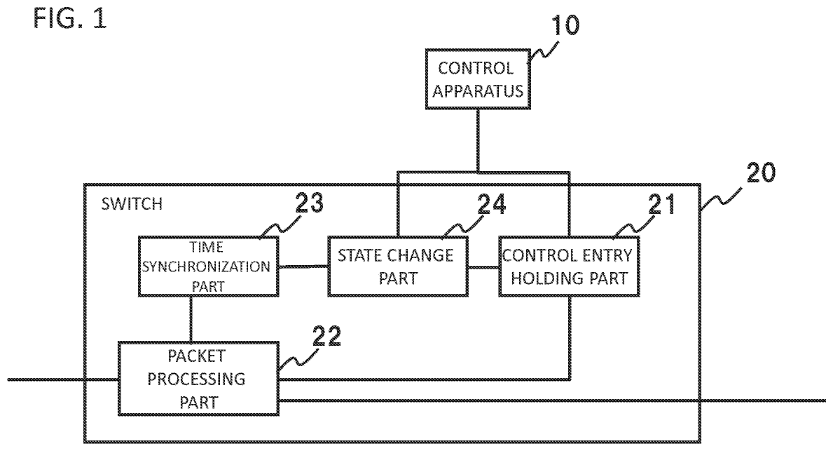

The present invention can be realized by a switch 20 which includes a control entry holding part 21, a packet processing part 22, a time synchronization part 23 and a state change part 24, in an example embodiment as shown in FIG. 1.

More concretely, the control entry holding part 21 holds a control entry(ies) set by a predetermined control apparatus. The packet processing part 22 processes a received packet with reference to the control entry(ies). Furthermore, the time synchronization part 23 performs time synchronization among a device(s) and an apparatus(es) mounted on a vehicle. Then, the state change part 24 changes a combination(s) of the control entry(ies) which the packet processing part refers to using a time for which the time synchronization has been performed. Here, it is assumed that a device(s) and an apparatus(es) include ECUs 30A to 30C as well as switches 20A, 20B.

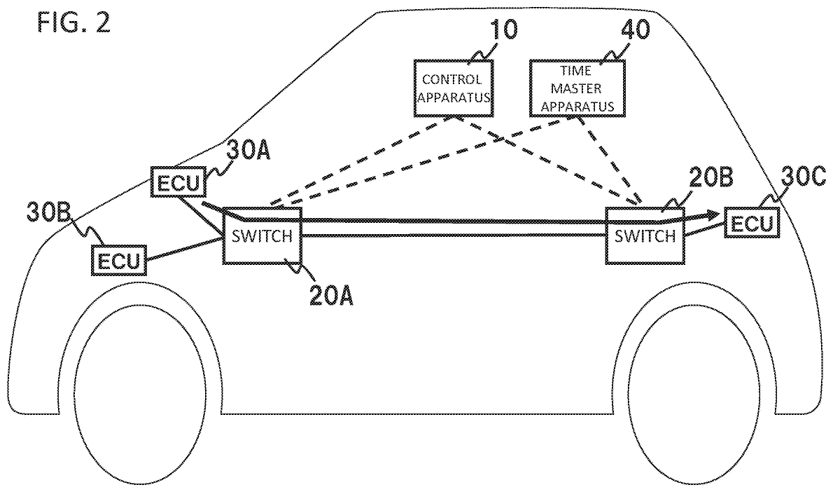

For example, as to the switch 20 described above, as shown in FIG. 2, there are provided a plurality of switches (refer to 20A, 20B) to control communication among ECUs 30A to 30C of the vehicle. Furthermore, it is assumed that these switches 20A and 20B are time synchronized with the time master apparatus 40 by the time synchronization part 23.

For example, at a time point, it is assumed that a control entry is set for transmitting a packet from an ECU 30A to an ECU 30C (refer to an arrow in FIG. 2). From this state, it is assumed that, at a time of XX:XX, a packet from the ECU 30A to the ECU 30C is blocked and a packet is transmitted from an ECU 30B to the ECU 30C.

In this case, the control apparatus 10 instructs the switch 20A to start dropping a packet from the ECU 30A to the ECU 30C at a synchronized time of XX:XX and start transmitting a packet from the ECU 30B to the ECU 30C at the synchronized time of XX:XX. Similarly, the control apparatus 10 instruct the switch 20B to start transmitting a packet from the ECU 30B to the ECU 30C at the synchronized time of XX:XX.

Then, the switch 20A performs the following operation at a timing when an own system time which is synchronized by the time synchronization part 23 becomes the time XX:XX. That is, the switch 20A enables the control entry for dropping the packet from the ECU 30A to the ECU 30C and the control entry for transmitting the packet from the ECU 30B to the ECU 30C to the switch 20B side, respectively.

Similarly, at a timing at which an own system time which is synchronized by the time synchronization part 23 becomes the time XX:XX, the switch 20B enables the control entry for transmitting the packet from the ECU 30B to the ECU 30C to the ECU 30C side.

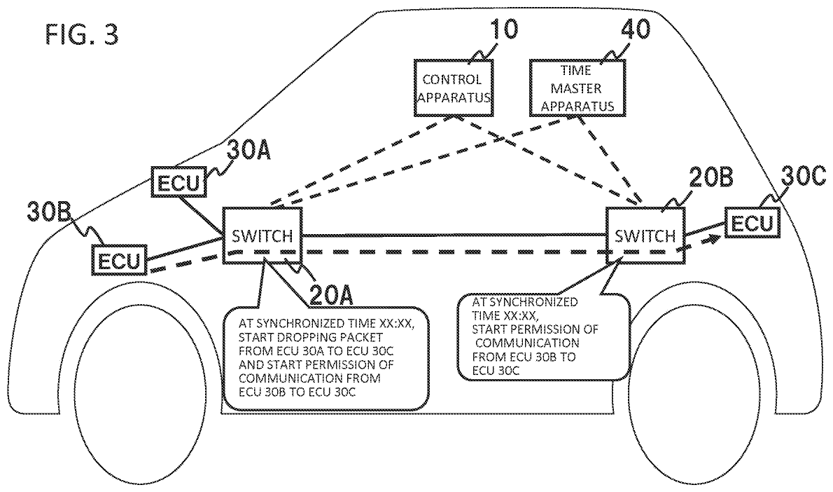

As described above, as shown in FIG. 3, it becomes possible to switch over, at the time XX:XX, from a state where a packet from the ECU 30A to the ECU 30C is transmitted to a state where a packet from the ECU 30B to the ECU 30C is transmitted at one time. For example, it is assumed that the ECU 30A is transmitting a video image from a visible light camera to the ECU 30C and the ECU 30B is transmitting a video image from an infrared camera to the ECU 30C. By applying the present invention, it is possible to switch over input for the ECU 30C from a visible light video image to an infrared video image at the time XX:XX when Y seconds has passed after entering a tunnel without causing packet loss.

### First Example Embodiment

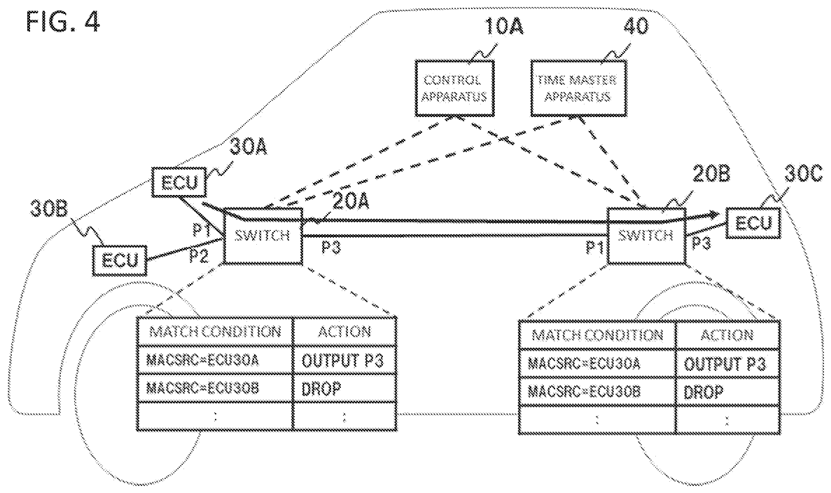

Next, a first example embodiment of the present invention will be described in detail with reference to drawings. FIG. 4 illustrates a configuration of a communication system (in-vehicle network system) of a first example embodiment of the present invention. With reference to FIG. 4, a configuration in which ECUs 30A, 30B and 30C, switches 20A and 20B, a control apparatus 10, and a time master apparatus 40 are connected is shown. Please note that reference signs P1 to P3 in FIG. 4 show port numbers of the switches 20A and 20B, respectively.

The control apparatus 10A, for example, can be configured by adding a function for instructing a timing at which a combination(s) of a plurality of control entries is(are) enabled to an apparatus equivalent to an SDN controller which sets a control entry(ies) to the switches 20A and 20B.

More concretely, the control apparatus 10 includes a time synchronization part 11, a control entry setting part 13, and a change control part 12. The time synchronization part 11 performs time synchronization of an own system time based on a difference between time stamp information received from the time master apparatus 40 and a reception time of the time stamp information. The control entry setting part 13 sets a control entry(ies) to a switch(es) to be controlled. The change control part 12 instructs change of a combination(s) of the control entry(ies) to the switch(es) to be controlled by designating the time. Therefore, the time synchronization part 11 performs time synchronization among a device(s) and an apparatus(es) mounted on a vehicle including the switches 20A and 20B.

The ECU 30A and 30B are, for example, connected to a camera(s) and a sensor(s) and respectively transmit data to the ECU 30C. Description will be performed by assuming that the ECU 30C is an ECU which controls a vehicle and outputs received data on a display apparatus based on data received from the ECU 30A and the ECU 30B.

The time master apparatus 40 is an apparatus selected as grand master of IEEE802.1AS which provides time stamp information to the switches 20A and 20B and the ECUs 30A to 30C. The time master apparatus 40 is assumed to be a dedicated apparatus as well as an apparatus including a time correction function using GPS (Global Positioning System) among an ECU and so on.

The switches 20A and 20B process the received packet(s) according to the control entry(ies) set by the control apparatus 10A.

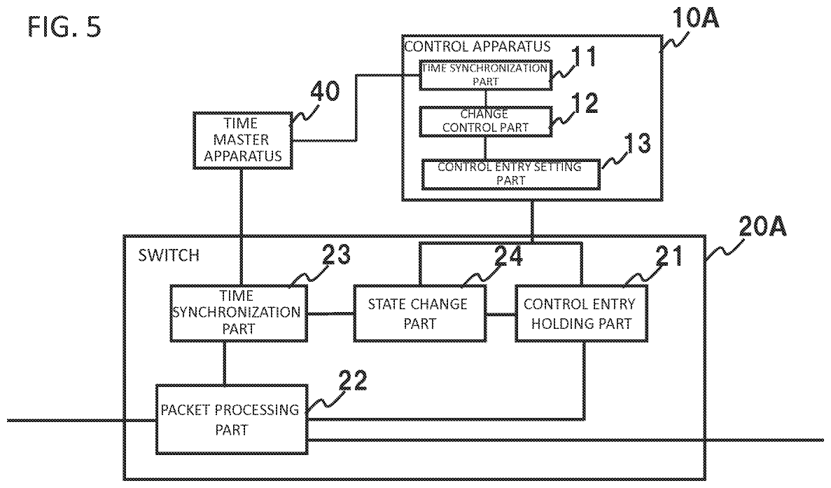

FIG. 5 illustrates a configuration of the switch 20A of the present example embodiment. With reference to FIG. 5, a configuration including a control entry holding part 21, a packet processing part 22, a time synchronization part 23, and a state change part 24 is shown. Please note that since the switch 20B has the same configuration as that of the switch 20A, the explanation will be omitted.

The control entry holding part 21 holds a control entry(ies) set by a predetermined control apparatus. The control entry holding part 21 corresponds to a flow table which an OpenFlow switch of NPL 1 holds.

When the packet processing part 22 receives a packet, the packet processing part 22 selects a control entry which has a match condition matching the received packet from the control entry holding part 21 and executes a processing content (action) set in the control entry.

The time synchronization part 23 performs synchronization of an own system time based on a difference between time stamp information received from the time master apparatus 40 and a reception time of the time stamp information. More concretely, the time synchronization part 23 calculates a difference between a time obtained by subtracting a network delay time value from the reception time of the time stamp information and a time indicated by the time stamp information received from the time master apparatus 40. For example, if the time obtained by subtracting a network delay time value from the reception time of the time stamp information is 3 millisecond behind, the time synchronization part 23 performs processing of setting a clock of an own apparatus ahead by 3 millisecond. In the explanation of the present example embodiment, IEEE802.1AS is used as a time synchronization protocol, however, other PTP (Precision Time Protocol) may be used.

The state change part 24 updates a table(s) held in the control entry holding part 21 using a time synchronized by above time synchronization part 23.

In the following description, as shown in a lower part of FIG. 4, it is assumed that, in an initial state, switches 20A and 20B are set in such manner that a packet from the ECU 30A is transmitted to the ECU 30C (output P3) and a packet from the ECU 30B is dropped. Please note that, in the following description, a MAC address (Media Access Control address) of a transmission source is used as a match condition for simplify the explanation (shown by “MACSRC” in drawings). It is, of course, possible to use other information as a match condition.

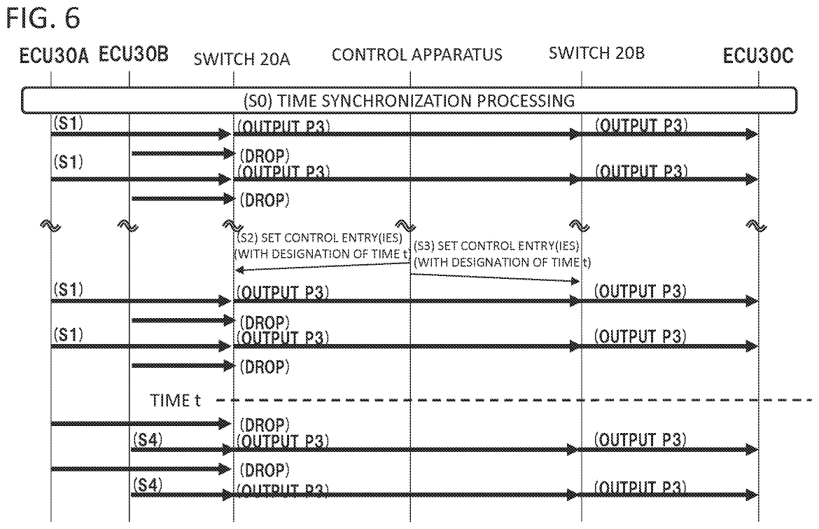

FIG. 6 shows a sequence diagram illustrating an operation of the first example embodiment of the present invention. With reference to FIG. 6, first, a time synchronization processing (step S0) is performed among the control apparatus 10A, the switch 20A and 20B, the ECUs 30A to 30C, and the time master apparatus 40 (omitted in FIG. 6). Please note that this time synchronization processing is performed repeatedly at a predetermined time interval.

Then, when a packet is transmitted from the ECU 30A, the switch 20A forwards the packet to the switch 20B by outputting the packet from the ECU 30A from a port P3 according to the initial setting. Similarly, the switch 20B forwards the packet transmitted from the ECU 30A to the ECU 30C (step S1).

On the other hand, when a packet is transmitted from the ECU 30B, the switch 20A drops the packet from the ECU 30B according to the initial setting (DROP).

Then, it is assumed that, due to change in vehicle state or an explicit operation by a driver, it becomes necessary to transmit a packet from the ECU 30B in place of the ECU 30A to the ECU 30C. In this case, the control apparatus 10A sets a control entry(ies) with designation of a time t to the switches 20A and 20B (steps S2 and S3). Please note that, as described later on, because the control entries set here are simultaneously enabled at the time t, a setting order of the control entries to the switches 20A and 20B can be changed.

After that, as shown in FIG. 6, the switches 20A and 20B continue the previous operation until the time t comes (step S1, refer to DROP).

When the time t comes, the switches 20A and 20B respectively perform processings to enable the control entries set in steps S2 and S3 and drop the previous control entries.

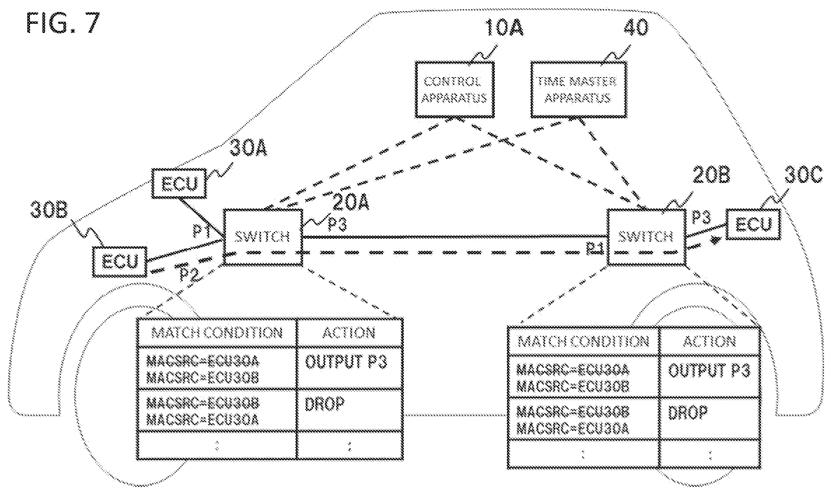

FIG. 7 illustrates an example of rewriting a control entry(ies) in the switches 20A and 20B and a packet transmission path switched over thereby.

When a packet is transmitted from the ECU 30A shown in FIG. 7, the switch 20A drops a packet from the ECU 30A according to the control entry set in step S2 (refer to an action “DROP” in FIG. 7 and DROP in FIG. 6).

On the other hand, when a packet is transmitted from the ECU 30B, the switch 20A forwards a packet from the ECU 30B to the switch 20B according to the control entry set in step S2. The switch 20B forwards the packet transmitted from the ECU 30B to the ECU 30C (refer to an arrow in FIG. 7 and step S4 in FIG. 6).

As described above, according to the present example embodiment, it becomes possible to implement change of a packet processing using a high precision time information corrected by using IEEE802.1AS and so on.

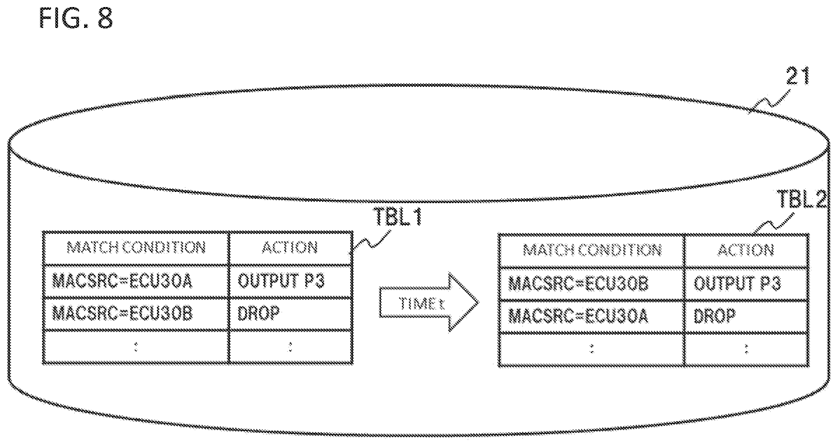

Here, with reference to FIG. 8, an example of a change method from an old control entry to a new control entry at the time t will be described. For example, TBL 1 shown in FIG. 8 is a flow table set in above initial state (before change). In above steps S2 and S3, a new control entry(ies) is(are) set in another table TBL 2. Then, when the time t comes, high speed switching of a plurality of control entries can be realized by switching over the table referred to by the packet processing part 22 from TBL 1 to TBL 2. Furthermore, according to the present example embodiment, it is possible to restore the table referred to by the packet processing part 22 from TBL 2 to TBL 1 at a point of a time t2 after the time t. Of course, it is possible to employ a method for sequentially switching a table referred to by the packet processing part 22 using three or more tables. Because methods for switching a control entry(ies) are not limited to these methods but there may be various variations, in the following description, there will be described as a second to fourth example embodiments.

### Second Example Embodiment

Next, a second example embodiment will be described, in which the change method of a control entry(ies) described above are modified. Hereinafter, since a second to fourth example embodiments can be realized by the same configuration as that of the first example embodiment, a difference thereof will mainly be described.

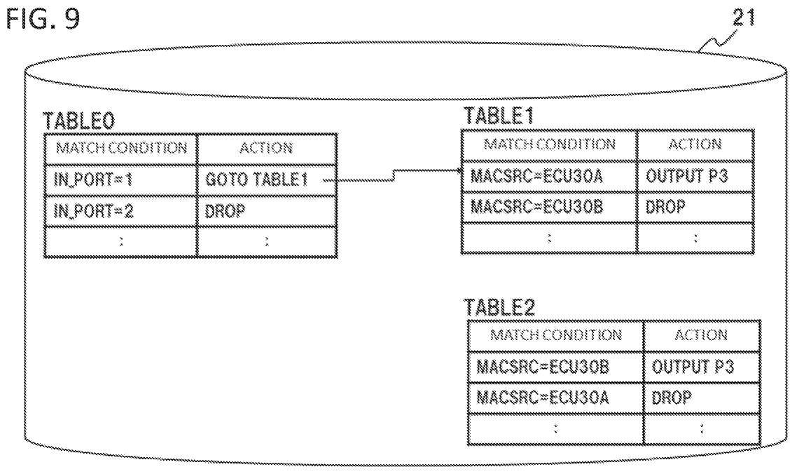

As shown in FIG. 9, in the present example embodiment, a plurality of tables TABLE0 to TABLE2 are provided in a control entry holding part 21 of the switches 20A and 20B (multi table configuration). When the packet processing part 22 receives a packet, the packet processing part 22 first refers to TABLE0. Then, if an instruction to refer to other table is set in an action of a control entry which has a match condition matching the received packet, the packet processing part 22 searches a control entry which has a match condition matching the received packet from the table. Then, the packet processing part 22 performs a content if there is a control entry which has a match condition in a referenced destination table.

In an example shown in FIG. 9, in an initial state (before change), an action which instructs to refer to a TABLE 1 for a packet of a port 1 (IN_PORT=1) as a match condition is set in a TABLE0. Then, the TABLE1 is set to transmit a packet from the ECU 30A to the ECU 30C (OUTPUT) and drop a packet from the ECU 30B (DROP). On the other hand, a TABLE2 is set to transmit a packet from the ECU 30B to the ECU 30C (OUTPUT) and drop a packet from the ECU 30A (DROP).

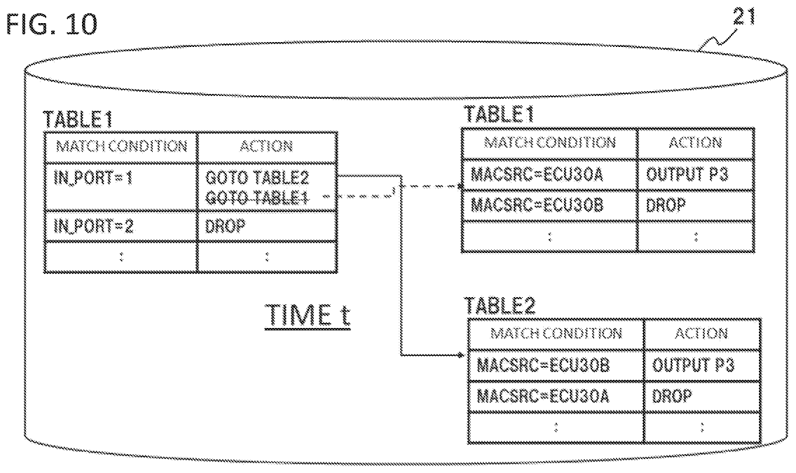

When a time t comes, the switches 20A and 20B rewrite referenced destinations of control entries (the control entries whose match condition of FIG. 10 is IN_PORT=1) designated respectively in the TABLE0 as shown in FIG. 10 from the TABLE 1 to the TABLE 2. As a result, the same switching of a path as that shown in FIG. 7 is realized.

As described above, the present invention can also be preferably applied to a switch which holds a control entry(ies) using a multi table configuration. In the present example embodiment, of course, it is possible to employ a method for sequentially switching a table referred to by the packet processing part 22 by providing three or more tables as referenced destination tables.

### Third Example Embodiment

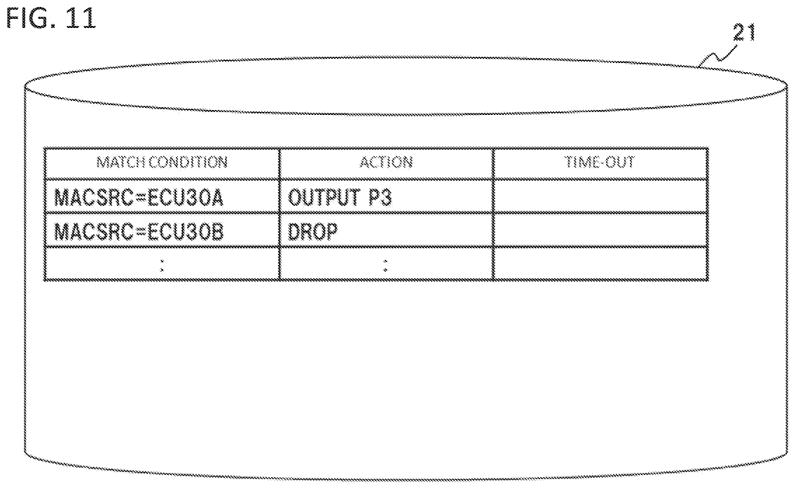

Next, a third example embodiment will be described, in which change of a control entry(ies) is performed by a time-out value. FIG. 11 shows control entries set in a table of an initial state (before change) in the present example embodiment. Contents of the control entries are the same as contents of TBL 1 as shown in FIG. 8 except that a time-out field is added.

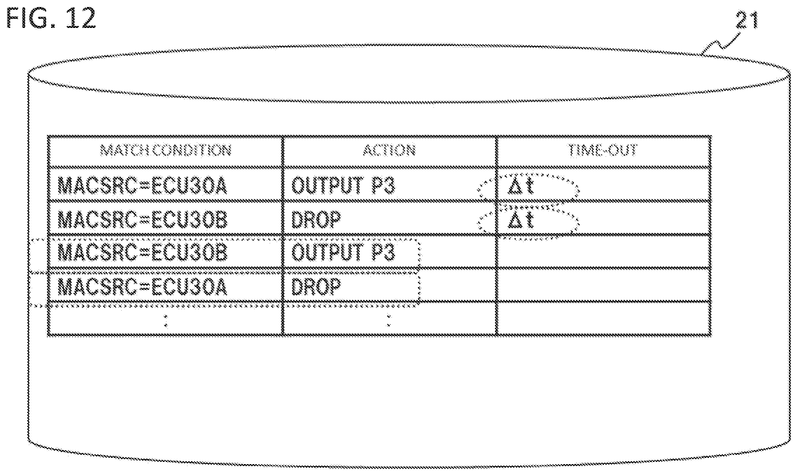

When the switches 20A and 20B of the present example embodiment receive a setting of the control entries with designation of a time t from the control apparatus 10A in steps S2 and S3 of FIG. 6, the switches 20A and 20B operate the control entries as shown in FIG. 12.

First, the switches 20A and 20B set a time-out value of the control entries which are to be disappeared at a time t. This time-out value indicates a duration time between setting a flow and deleting the control entry (hard time-out value). Concretely, the switches 20A and 20B set a difference Δt between the designated time t and a current time Tcurr as the time-out value. Then, the switches 20A and 20B delete the control entries which are to be disappeared at the time t when Δt elapses. Please note that the current time Tcurr is a system time of the switches 20A and 20B side synchronized by the time synchronization part 23.

Furthermore, the switches 20A and 20B set control entries to be applied from the time t instructed from the control apparatus 10A apart from the control entries which are to be disappeared at the time t. These control entries are given lower priority than the control entries which are to be disappeared at the time t.

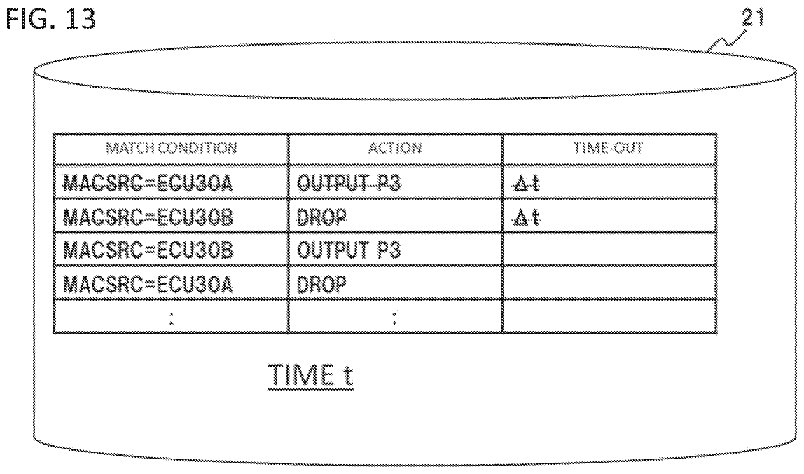

FIG. 12 shows a table in a state where the above operations have been done. After that, Δt which is set as the time-out value elapses when the time t comes, whereby the control entries which are to be disappeared at the time t are deleted as shown in FIG. 13. As a result, the same switching of a path as that shown in FIG. 7 is realized.

As described above, the change of the control entries of the present invention can be realized by using time-out (hard time-out). Please note that setting of the time-out value to the control entry(ies) can also be realized in such a manner that the control apparatus 10A instructs the switches 20A and 20B. Please note that, although in the above example embodiment, it is explained to use a time-out function which is mounted on a switch, any control entry(ies) may be deleted by directly designating a time without using time-out. For example, it is possible to realize switchover of a control entry(ies) in the same way by designating a time such as a time hh:mm:ss.sss (hh hours mm minutes ss seconds sss milliseconds) in place of the time-out value Δt as described above.

### Fourth Example Embodiment

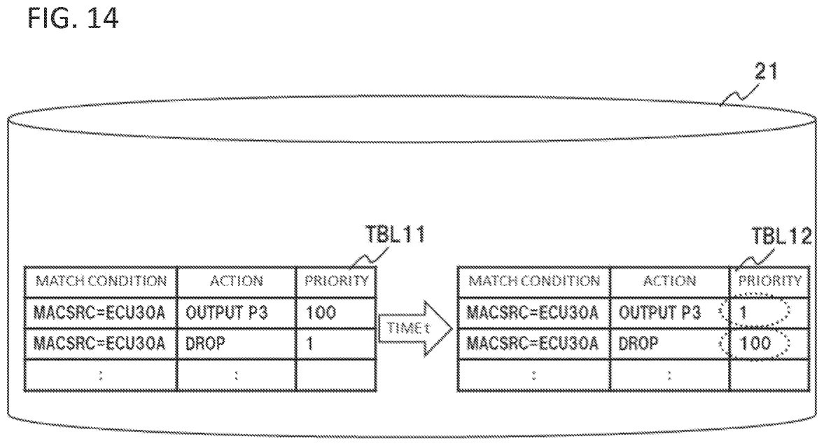

Next, a fourth example embodiment will be described, in which change of a control entry(ies) are performed by changing of priority information. FIG. 14 shows control entries set in a table before and after change in the present example embodiment. A value set in a priority field indicates priority, and the larger a value, higher the priority of the control entry.

A TBL 11 shown in FIG. 14 shows a table before change. Control entries having the same match condition MACSRC=ECU30A are registered. In a state of the TBL 11, because the control entry whose action is OUTPUT has higher priority than that of another control entry, a packet transmitted from the ECU 30A is to be forwarded to the ECU 30C side.

When the time t comes, the switches 20A and 20B rewrite priority of the TBL 11 to be changed to as shown in TBL 12. In a state of the TBL 12, the control entry whose action is DROP becomes to have higher priority than another control entry, a packet transmitted from the ECU 30A is to be dropped.

As described above, the change of the control entry(ies) of the present invention can be realized by rewriting priority which can be set to the control entry(ies). Please note that the setting priority to the control entry can be realized by instruction of the control apparatus 10A. Of course, in the first to fourth example embodiments, it is possible to employ a method for changing priority of existing control entries in addition to switchover of tables and time-out of a control entry(ies).

As above, each example embodiment of the present invention is described, the present invention is not limited to above example embodiments, further modifications, replacement and adjustment can be added to without departing from basic technical concept of the present invention. For example, a network configuration, a configuration of each element, and a message representational form shown in each drawing are examples to facilitate understanding of the present invention and the present invention is not limited to a configuration shown in each drawing.

Furthermore, in the above example embodiments, examples to mainly switch over paths by changing the control entries are described, uses of the present invention are not limited to that. For example, by setting different processing contents to the control entries, it is applicable for use to simultaneously switch over processing contents for a packet(s) (rewriting headers, and so on) by a plurality of switches at a fixed time and so on.

For example, in the above example embodiments, examples of an in-vehicle network including two switches and three ECUs are described, the number of switches and the number of ECUs are not limited thereto. Furthermore, the present invention can be applied not only to the in-vehicle network but also to a communication system having a configuration in which control apparatuses and switches respectively play roles of a control plane and a data plane.

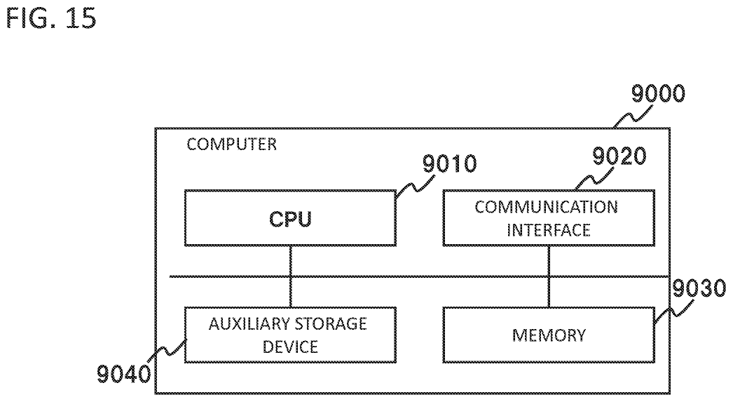

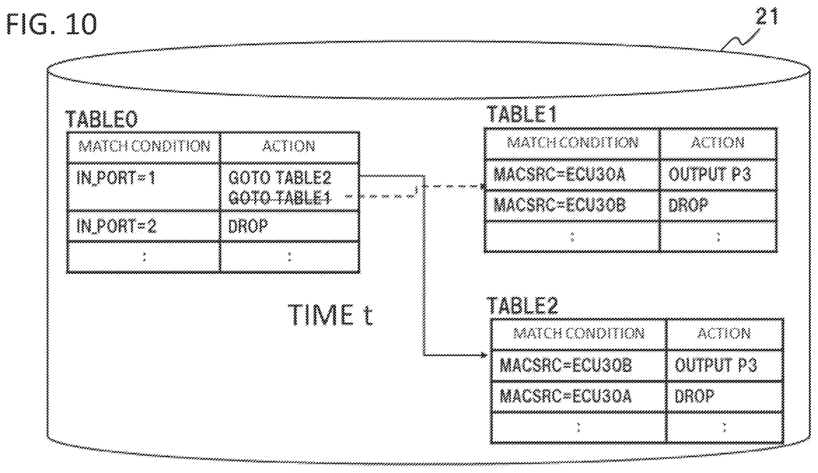

Furthermore, procedures shown in the above first to fourth example embodiments can be realized by a program which causes a computer (9000 as shown in FIG. 15) mounted on the switches 20A and 20B to realize functions as a switch. Such a computer is exemplified by a configuration as shown in FIG. 15 including a CPU (Central Processing Unit) 9010, a communication interface 9020, a memory 9030 and an auxiliary storage device 9040. That is, the CPU 9010 shown in FIG. 15 executes a time synchronization program and a control entry change program and may perform an update processing of each calculation parameter held in the auxiliary storage device 9040 and so on.

That is, each part (processing means, functions) of the switches 20A and 20B shown in the above first to fourth example embodiments can be realized by a computer program that causes processors mounted on these switches to execute each processing using its hardware.

Finally, preferred modes of the present invention are summarized as below.

### [Mode 1]

(Refer to the switch from the first aspect.)

### [Mode 2]

It is possible to employ a configuration in which the control entry holding part of the switch described above holds a plurality of tables each of which has a different combination of the control entry(ies), and the state change part switches over a table which the packet processing part refers to according to the time.

### [Mode 3]

It is possible to employ a configuration in which the state change part of the switch described above switches over a table which the packet processing part refers to by changing a referenced destination table in a control entry that instructs to refer to other table, out of the control entry(ies) held in the control entry holding part.

### [Mode 4]

It is possible to employ a configuration in which the state change part of the switch described above changes the combination of the control entry(ies) by setting a time-out value based on the time to the control entry(ies).

### [Mode 5]

It is possible to employ a configuration in which the state change part of the switch described above changes priority given to the control entry(ies) in place of the change of the combination of the control entry(ies) or in addition to the change of the combination of the control entry(ies).

### [Mode 6]

It is possible to employ a configuration in which a time synchronization part of the switch described above performs time synchronization using a predetermined protocol to correct a time based on a difference between time stamp information received from a predetermined master apparatus and a reception time of the time stamp information.

[Mode 7]

(Refer to the control apparatus from the second aspect.)

### [Mode 8]

It is possible to employ a configuration in which the control apparatus described above instructs the switch(es) to set a time-out value(s) to a designated control entity(ies) in such a manner that a combination(s) of the control entity(ies) is(are) changed at a designated time.

### [Mode 9]

It is possible to employ a mode in which the control apparatus described above instructs the switch(es) of the above each mode to set a time-out value(s) to a designated control entity(ies) in such a manner that a combination(s) of the control entity(ies) is(are) changed at a designated time.

### [Mode 10]

(Refer to the communication system from the third aspect.)

[Mode 11]

It is possible to employ a mode in which a communication control method from the fourth aspect, wherein in a switch comprising: a control entry holding part which holds a control entry(ies) set by a predetermined control apparatus; and a packet processing part which processes a received packet with reference to the control entry(ies); the following steps are performed, comprising: a step of performing time synchronization among a device(s) and an apparatus(es) mounted on a vehicle; and a step of changing a combination of the control entry(ies) which the packet processing part refers to using a time for which the time synchronization has been performed.

### [Mode 12]

It is possible to employ a mode in which a program from the fifth aspect that causes a computer mounted on a switch comprising: a control entry holding part which holds a control entry(ies) set by a predetermined control apparatus; and a packet processing part which processes a received packet with reference to the control entry(ies); to execute processings, comprising: performing time synchronization among a device(s) and an apparatus(es) mounted on a vehicle; and changing a combination of the control entry(ies) which the packet processing part refers to using a time for which the time synchronization has been performed.

Please note that the tenth to twelfth modes can be expand to the second to sixth modes as is the case with the first mode.

Please note that each disclosure of the above Patent Literatures and a Non Patent Literature is incorporated herein by reference thereto. Variations and adjustments of the example embodiments and examples are possible within the scope of the overall disclosure (including the claims) of the present invention and based on the basic technical concept of the present invention. Various combinations and selections (including partial deletion) of various disclosed elements (including each of the elements in each of the claims, example embodiments, examples, drawings, etc.) are possible within the scope of the entire disclosure of the present invention. Namely, the present invention of course includes various variations and modifications that could be made by those skilled in the art according to the overall disclosure including the claims and the technical concept. In particular, with respect to the numerical ranges described herein, any numerical values or small range(s) included in the ranges should be construed as being expressly described even if not particularly mentioned.

### SIGNS LIST

10, 10A control apparatus (controller)
11 time synchronization part
12 change control part
13 control entry setting part
20, 20A, 20B switch
21 control entry holding part
22 packet processing part
23 time synchronization part
24 state change part
30A, 30B 30C ECU
40 time master apparatus
TBL1, TBL2, TBL11, TBL12 table
9000 computer
9010 CPU
9020 communication interface
9030 memory
9040 auxiliary storage device

What is claimed is:

1. A switch, comprising:
at least a processor; and
a memory in circuit communication with the processor,
wherein the processor is configured to execute program instructions stored in the memory to implement:
a control entry holding part which holds a control entry(ies) set by a predetermined control apparatus;
a packet processing part which processes a received packet with reference to the control entry(ies);
a time synchronization part which performs time synchronization among a device(s) and an apparatus(es) mounted on a vehicle; and
a state change part which changes a combination of the control entry(ies) which the packet processing part refers to using a time for which the time synchronization has been performed.

2. The switch according to claim 1, wherein
the control entry holding part holds a plurality of tables each of which has a different combination of the control entry(ies), and
the state change part switches over a table which the packet processing part refers to according to the time.

3. The switch according to claim 2, wherein
the state change part switches over a table which the packet processing part refers to by changing a referenced destination table in a control entry that instructs to refer to other table, out of the control entry(ies) held in the control entry holding part.

4. The switch according to claim 1, wherein
the state change part changes the combination of the control entry(ies) by setting a time-out value based on the time to the control entry(ies).

5. The switch according to claim 1, wherein
the state change part changes priority given to the control entry(ies) in place of the change of the combination of the control entry(ies) or in addition to the change of the combination of the control entry(ies).

6. The switch according to claim 1, wherein
the time synchronization part performs time synchronization using a predetermined protocol to correct a time based on a difference between time stamp information received from a predetermined master apparatus and a reception time of the time stamp information.

7. A control apparatus, comprising:
at least a processor; and
a memory in circuit communication with the processor,
wherein the processor is configured to execute program instructions stored in the memory to implement:
a control apparatus side time synchronization part which performs time synchronization among a device(s) and an apparatus(es) mounted on a vehicle;
a control entry setting part which sets a control entry(ies) to a switch(es) to be controlled; and
a change control part which instructs change of a combination(s) of the control entry(ies) to the switch(es) to be controlled by designating a time for which the time synchronization has been performed.

8. The control apparatus according to claim 7, wherein the control apparatus instructs the switch(es) to set a time-out value(s) to a designated control entity(ies) in such a manner that a combination(s) of the control entity(ies) is(are) changed at the designated time.

9. The control apparatus, wherein the control apparatus instructs a timing at which the combination(s) of the control entity(ies) is(are) changed to the switch(es) according to claim 1.

10. A communication system, comprising:
at least a processor; and
a memory in circuit communication with the processor,
wherein the processor is configured to execute program instructions stored in the memory to implement:
a switch(es) each of which comprises:
a control entry holding part which holds a control entry(ies) set by a predetermined control apparatus;
a packet processing part which processes a received packet with reference to the control entry(ies);
a time synchronization part which performs time synchronization among a device(s) and an apparatus(es) mounted on a vehicle; and
a state change part which changes a combination of the control entry(ies) which the packet processing part refers to using a time for which time synchronization has been performed; and
a control apparatus which instructs a timing at which the combination(s) of the control entity(ies) is(are) changed to the switch(es).

11.-12.

13. The communication system to claim 10, wherein
the control entry holding part holds a plurality of tables each of which has a different combination of the control entry(ies), and
the state change part switches over a table which the packet processing part refers to according to the time.

14. The communication system according to claim 13, wherein
the state change part switches over a table which the packet processing part refers to by changing a referenced destination table in a control entry that instructs to refer to other table, out of the control entry(ies) held in the control entry holding part.

15. The communication system according to claim 10, wherein
the state change part changes the combination of the control entry(ies) by setting a time-out value based on the time to the control entry(ies).

16. The communication system according to claim 10, wherein
the state change part changes priority given to the control entry(ies) in place of the change of the combination of the control entry(ies) or in addition to the change of the combination of the control entry(ies).

17. The communication system according to claim 10, wherein
the time synchronization part performs time synchronization using a predetermined protocol to correct a time based on a difference between time stamp information received from a predetermined master apparatus and a reception time of the time stamp information.

18. The communication system according to claim 10, wherein the control apparatus instructs the switch(es) to set a time-out value(s) to a designated control entity(ies) in such a manner that a combination(s) of the control entity(ies) is(are) changed at the designated time.

19. The communication system according to claim 10, wherein the control apparatus instructs a timing at which the combination(s) of the control entity(ies) is(are) changed to the switch(es).
